(19) United States
(12) Patent Application Publication
(10) Pub. No.: US 2011/0207364 A1
(43) Pub. Date: Aug. 25, 2011

(54) TERMINATION TOOL, INSULATION DISPLACEMENT CONNECTOR (IDC) BLOCK AND METHOD FOR ELECTRICALLY CONNECTING AN ELECTRICAL CONDUCTOR TO AN IDC BLOCK

(76) Inventors: Guy Metral, Cluses (FR); Xavier Fasce, Verchaix (FR)

(21) Appl. No.: 12/673,017

(22) PCT Filed: Aug. 5, 2008
(86) PCT No.: PCT/US08/72208

§ 371 Date: Feb. 11, 2010

Related U.S. Application Data
(60) Provisional application No. 60/957,861, filed on Aug. 24, 2007.

(51) Int. Cl. H01R 4/24

(52) U.S. Cl. 439/404

(57) ABSTRACT

The invention comprises a termination tool (1) for terminating electrical conductors (19) to an insulation displacement connector (IDC) block (11) comprising: at least one anchor portion (2) for fixing the termination tool to the IDC block; at least one body portion (3) pivotable between an open position and a closed position relative to the IDC block for urging at least one electrical conductor into an IDC element of the IDC block and an integral hinge (4) portion between the anchor portion and the body portion that enables the body portion to pivot between the open position and the closed position. The invention also comprises an insulation displacement connector (IDC) block (11) having the inventive termination tool secured thereto. The invention further comprises a method of electrically connecting an electrical conductor to an insulation displacement (IDC) block by using the inventive termination tool.

### FIELD OF THE INVENTION

The invention relates to a termination tool for an insulation displacement connector (IDC) block or simply connector block, an IDC block and a method for electrically connecting an electrical conductor to an IDC block.

### BACKGROUND OF THE INVENTION

In a telecommunication context, a first set of connector blocks are connected to cables (i.e. electrical conductors) that feed subscribers while another set of connector blocks are connected to cables to the central office. To make the electrical connection between the subscriber blocks and the central office blocks, jumper wires are inserted to complete the electrical circuit. Typically jumper wires can be connected, disconnected, and reconnected several times as the consumer's needs change.

An IDC element may be used to electrically connect to a wire or electrical conductor to the IDC block. The IDC element displaces or cuts through the insulation from a portion of the electrical conductor when the electrical conductor is inserted into a slot within the IDC element so the IDC element makes electrical connection to the electrical conductor. Once the electrical conductor is inserted within the slot with the insulation displaced, electrical contact is made between the conductive surface of the IDC element and the conductive core of the electrical conductor.

Typically, the IDC element is housed in an insulated housing. The housing may have a cap or another movable member that is movable to press the electrical conductor into contact with the IDC element. U.S. Pat. No. 7,165,983 B1 and US 2006/0 160 404 A1 each disclose an IDC block with a termination tool integrated in the block. The IDC blocks comprise a housing for contacts with IDC elements as well as a cap that is pivotally attached to the housing over a pivot axis to cover each pair of contacts. By pivoting the cap from an open position into a closed position relative to the housing, it is possible to force the electrical conductor into the IDC element of the contact. The electrical conductor is simultaneously cut to an appropriate length when the cap is closed. The known caps consist of plural parts.

EP 0 994 528 A2 discloses an IDC block with an integrated termination tool. The IDC block comprises several housings with contacts having IDC elements integrated into the housing. Each housing comprises a separate cap that is pivotally attached to the housing over a hinge. By pivoting the cap from an open position into a closed position relative to the housing it is possible to force an electrical conductor into an IDC element of a contact. The electrical conductor has to be cut before insertion to the appropriate length.

DE 693 07 224 T2 discloses a socket for a modular jack having a housing with a rotating cover. The rotating cover functions as a tool for connecting electrical conductors with self-stripping contacts by closing the cover. The rotating cover is joined to the housing by a pivot axis.

There is a need for a termination tool for terminating electrical conductors to an IDC block with IDC elements that has a simple construction and is therefore easy and cost effective to manufacture. The termination tool further has to be easy to handle that means that it has to be easy to attach to the IDC block as well as easy to urge on the electrical conductors that has to be terminated into the IDC element. The termination tool should also be adapted to be retrofitable to an IDC block.

### SUMMARY OF THE INVENTION

The present invention provides a termination tool for terminating electrical conductors to an IDC block comprising at least one anchor portion for fixing the termination tool to an IDC block and at least one body portion pivotable between an open position and a closed position relative to the IDC block for urging at least one electrical conductor into an IDC element of the IDC block. The present invention further comprises an integral hinge portion between the anchor portion and the body portion that enables the body portion to pivot between the open position and the closed position.

The IDC block may comprise a housing. The housing may be made of plastic or any other suitable material and can be constituted by one or more components. The housing may consist of one part or of several parts. The housing serves to accommodate telecommunication contacts, to which telecommunications lines are connectable. The housing can also have specific structures for positioning the contacts therein. Moreover, the housing can comprise one or more cavities or receiving spaces which are adapted to accommodate the contacts and/or further objects such as one or more protection modules or any other types of outside modules or parts thereof. Finally, the housing can comprise suitable structures, typically at the outside thereof, to enable the telecommunications module to be mounted to a rack or any other suitable carrier in the field of telecommunications.

As will be apparent to those skilled in the art, a telecommunications line will normally be constituted by a pair of wires. Similarly, the telecommunications contacts are also arranged in pairs. Moreover, telecommunications modules are known in which the telecommunications contacts are arranged in two or more parallel rows, with pairs of contacts being located opposite to each other. Those pairs may have a disconnection point for providing an electrical connection between the contacts in a normal stage and for disconnecting them in another stage for example for testing reasons. The telecommunications modules can have the shape of a strip. It is also known in the prior art that these kind of contacts comprise IDC elements for making electrical connection to an electrical conductor.

The termination tool may be made of plastic, such as for example polybutylene terephtalate (PBT) or any other suitable material, such as for example glass fibre reinforced plastic. PBT is a plastic that is used as an insulator in the electrical and electronics industries. It is thermoplastic crystalline polymer, and a type of polyester. PBT is resistant to solvents, shrinks very little during forming, is mechanically strong, het-resistant up to 150° C. (or 200° C. with glass-fibre) and can be treated with flame retardants to make it noncombustible. It may further be constituted by one or more components. The anchor portion for fixing the termination tool to the IDC block and the body portion for urging at least one electrical conductor into an IDC element of the IDC block may also be made of plastic or any other suitable material. Making these portions out of plastic has the advantage that they can be easy manufactured by injection moulding. The integral hinge portion according to the invention may be a part that is integrated into the assembly of the termination tool during mounting of the termination tool. But it may also be an integral part in the sense that the termination tool consists of only one part and the hinge portion connects the anchor portion to the body portion of the termination tool. Using several components may have the advantage of having the possibility of using different materials and that may have the advantage of having a material with optimal properties at each portion of the termination tool.

The termination tool may be assigned to one contact, to one contact pair, to a row of contacts and/or to several rows of contacts. The shape and the size of the termination tool varies depending on the number of contacts that it covers.

As mentioned above the termination tool according to the invention may be manufactured out of one piece comprising several portions as for example an anchor portion, a body portion and a integral hinge portion. This has the advantage that the inventive termination tool is easy to manufacture and easy to handle. If the whole termination tool is made out of plastic it can be produces by injection moulding in a single step. This production method is extremely cost effective since several termination tools can be produced in a single shot. If it is made out of another material or the different portions of the termination tool are made using more than one material, the inventive termination tool still offers handling and assembly advantages because it is a single piece. The termination tool consisting of one piece is easy to handle because the one piece can be mounted to the IDC block by using one hand. There is no need to use a second hand because there are not several parts that have to be assembled.

The termination tool comprises several portions each portion having a separate function. The anchor portion has the function to fix, attach or secure the termination tool to the IDC block, for example the housing of the IDC block. Therefore, it may by advantageous for this portion to be relatively rigid to ensure that the connection between the IDC block and the termination tool resists uses of the termination tool. As described above jumper wires can be connected, disconnected, and reconnected several times as the consumer's needs change. Therefore, the anchor portion ensures that the termination tool still remains properly fixed or secured to the IDC block during connecting, disconnecting and reconnecting the electrical conductors. The hinge portion enables the body portion to pivot between an open position and a closed position relative to the IDC block and retains the body portion when it is opened so that it does not become separated from the block. Therefore, this portion should be resilient enough to allow a swivelling of the body portion relative to the anchor portion and the block while still being able to withstand repeated connecting, disconnecting and reconnecting of the electrical conductors. The body portion has the function of urging at least one electrical conductor into an IDC element. A certain amount of force is needed to make a reliable connection between an electrical conductor and an IDC element since first the insulation of the conductor has to be displaced and then the conductor itself has to be properly seated into the slot of the IDC element. Therefore the body portion has to have at least one rigid part with which it is possible to urge the electrical conductor into the IDC element.

The termination tool according to the invention may be made out of one piece consisting of different materials for example different kinds of plastic. With this kind of construction, it would be possible to adapt each portion of the termination tool to its function. For example the body portion and the anchor portion could comprise parts out of a more rigid plastic and the hinge portion could be made out of a more resilient plastic. This type of part may be manufactured for example in a two step injection moulding process or an insert moulding process. Alternatively a single material for example a plastic may be selected that fulfils all the different requirements for different portions. For example, by carefully controlling the geometrical shape of the different portions, the rigidity and/or the resilience of the termination tool can be adapted to its function. It is also possible to produce a termination tool consisting of several parts that are assembled together, e.g. by gluing, welding or special shapes such as dovetails, to yield the inventive termination tool.

When the termination tool is assigned to one contact or to a pair of contacts, it may comprise one body portion attached to an anchor portion, the body portion being able to urge one wire into one IDC element or two wires into two IDC elements of a pair of contact elements. When the termination tool is assigned to a row of contacts or contact pairs, it may comprise one body portion attached to an anchor portion wherein several anchor portions are arranged in a row. The anchor portions may be connected to each other so that one termination tool serves one row of contacts or contact pairs.

The termination tool may also comprise more than one body portion, e.g. two body portions, each fixed by an integral hinge portion to an anchor portion. Such a configuration could be symmetric where two body portions are fixed at opposite sides of the anchor portion. In such a case, the inventive termination tool may be used for an IDC block with two adjacent contacts or two adjacent rows of contacts. In an alternative embodiment, the two body portions may be arranged asymmetrically relative to the anchor portion. In another embodiment more than two body portions may be arranged around the anchor portion. When the termination tool is assigned to two adjacent rows of contacts or contact pairs it may comprise two body portions at one anchor portion and several anchor portions are arranged in a row. The anchor portions may be connected to each other so that one termination tool serves two rows of contacts or contact pairs.

According to one embodiment of the present invention, the integral hinge portion may be a living hinge. A living hinge is a hinge or flexure bearing with no moving parts. It is generally a thin section of material that bends to allow movement. The lack of any friction and very little wear in such a hinge are very advantageous. The ease of manufacturing and assembly of the tool due to the reduced part count increases the cost savings as well. Living hinges may be made out of polypropylene due to its excellent fatigue resistance but other materials can be used for the living hinge as well.

According to another embodiment of the present invention, the body portion comprises at least one through-hole or wire guide for the electrical conductor to pass through the body portion. The function of the body portion is to urge the electrical conductor into the IDC element. When the body portion has a through-hole or a wire guide for the electrical conductor passing through the body portion it is possible to insert the electrical conductor through that through-hole before pushing the body portion into its closed position and inserting the electrical conductor into the IDC element. That has the advantage that the electrical conductor does not have to be cut to the right length before termination but can be cut after termination. When the IDC element is part of an IDC block with several IDC elements and the termination tool is assigned to the whole row of contacts or pairs of contacts, all electrical conductors can be cut of at once to the adequate length after they all had been connected with the help of the termination tool to the IDC elements. This procedure can save a lot of time and therefore money during the installation of the wires into the IDC block.

According to a further embodiment of the present invention, the body portion of the termination tool may comprise a guiding area for urging the electrical conductor into the IDC element of the IDC block. Since during insertion of the electrical conductor into the IDC element the insulation of the electrical conductor is displaced a certain amount of force has to be applied to the electrical connector. Therefore, the body portion of the termination tool comprises a specially designed area that is capable to guide, force and/or urge the conductor into the IDC element. For example, the guiding area may be adapted to the shape of an electrical conductor and be u-shaped or it may comprise a wire hugger-area and/or a wire stuffer-area, whereby the wire stuffer would be aligned with the IDC element. When the body portion is swivelled into its closed position, the underside of the wire stuffer engages the electrical conductor. The wire hugger and the wire stuffer engage with an upper exposed surface of the electrical conductor. Upon complete closure of the cap, the wire stuffer follows and pushes the electrical conductor into the IDC element while the wire hugger guides and aligns the electrical conductor with the IDC element. Other designs of the underside of the body portion are also possible.

The termination tool may comprise at least one aperture for providing a test access to the IDC block. A test access aperture allows the insertion of a test probe to make certain measurements at the contacts within the IDC block. A test access aperture enables a craftsman to engage the contacts of the IDC block without having to open or remove the termination tool. When a termination tool is mounted on an IDC block it is an advantage to have an aperture in the termination tool to grant access to the IDC block underneath the termination tool thereby preventing a disassembly of the arrangement IDC block with termination tool in each case of testing. The aperture for the test access may be located at least partially in the anchor portion of the termination tool as well as at least partially in the body portion depending on the shape of the IDC block and the arrangement of the contacts therein. It is also possible to locate it partially in the hinge portion.

The termination tool according to the present invention may also comprise an opening for filling a sealant component, e.g. a gel, into the IDC block to provide environmental protection. The sealant may be inserted into the IDC block before mounting the termination tool on the IDC block. Alternatively, the sealant may be added to the IDC block after mounting the termination tool on the IDC block. It is also possible that a part of the gel is filled into the IDC block before mounting the termination tool on the IDC block and another part after mounting the termination tool to the IDC block. The opening for filling gel into the IDC block may be at least partially in the anchor portion of the termination tool as well as at least partially in the body portion depending of the shape of the IDC block and the arrangement of the contacts therein. It is also possible to locate it partially in the hinge portion. According to a preferred embodiment of the invention the through-hole for the electrical conductor in the body portion may be used as the opening for filling gel into the IDC block. This construction simplifies the geometry of the termination tool since it provides openings with a double function and therefore helps to provide a cost saving part.

The termination tool further may comprise at least one fixing element for fixing the anchor portion to the IDC block, this fixing element being positioned on the anchor portion itself The fixing elements may be protrusions or snap fits that cooperate with corresponding elements, e.g. indents or holes, in the IDC block, e.g. in the housing of the IDC block. The advantage of having protrusions or snap fits for fixing, attaching or securing the anchor portion to the IDC block is that no further parts such as screws or bolts are needed for securing the termination tool to the IDC block and the termination tool can be mounted with one hand by positioning it into the right place and forcing the protrusions or snap fits of the anchor portion to cooperate with the corresponding elements of the IDC block. Of course it is also possible to use separate fixing elements such as screws, bolts, etc to secure the termination tool to the IDC block. That has the advantage that standard parts can be used.

The termination tool may comprise further at least one securing element for fixing or securing the body portion to the IDC block after it has been swivelled from its open position in its closed position after having urged at least one electrical conductor into an IDC element to prevent the tool from opening again. The securing elements may be for example latches. To keep the body portion in its closed position has two advantages. The first one is that the electrical conductor is kept in place. The second one is that the connection between the IDC element and the electrical conductor is covered and thereby protected from contamination e.g. from dust and/or other debris. When the IDC block is filled with sealant, the body portion further acts as cover preventing loss of the sealant. As the fixing elements of the anchor portion the securing elements of the body portion may cooperate by a snap fit with corresponding catch elements on the IDC block. Those snap fits have the above mentioned advantages—integral part and handle with one hand.

The termination tool according to the present invention may have an anchor length that is adapted to the length of the IDC block to which it is attached. Such a termination tool would be designed to fit to one IDC block with one or several rows of contacts. When the termination tool is assigned to at least one row of contacts a time saving termination tool is being provided to the user since by fixing one termination tool to the IDC block every IDC element in a row or in two adjacent rows of the IDC block can be equipped with a termination tool helping to terminate an electrical conductor.

The invention further provides an IDC block with at least one housing and at least two electrical contacts with IDC elements. The electrical contacts are positioned in the at least one housing. The IDC block further comprises a termination tool that provides the features described above.

For providing a comfortable assembly of IDC block and termination tool the IDC block may comprises a gap for receiving the anchor portion of the termination tool. A gap that is especially designed for receiving the anchor portion of the termination tool has the advantage to facilitate a perfect fit of the termination tool in the IDC block. As described above jumper wires tend to be connected, disconnected, and reconnected several times as the consumer's needs change and therefore the body portion of the termination tool needs to be swivelled each time from an open position to a closed position and vice versa. For that kind of demands a close fit between those two parts is advantageous.

The gap may comprise at least one indent or a hole to cooperate with the fixing element of the anchor portion of the termination tool. The anchor portion may be an integral part of the housing of the IDC block or it may be a separate part. The advantages of both solutions have been described above with respect to the fixing element of the anchor portion.

The gap in the IDC block for the termination tool may also function as a test access port to enable the insertion of a test probe to engage the contacts in the IDC block. In that application the gap has to be a through-hole to allow the insertion of a test probe so that a measurement may be made at the contacts inside the IDC block.

The IDC block may also comprise at least one securing portion cooperating with a securing element of the body portion. The securing portion may be an integral part of the housing of the IDC block or it may be a separate part. For the advantages of both solutions please see above.

The invention further comprises a method of electrically connecting an electrical conductor to an insulation displacement connector (IDC) block, the method comprising:
providing an insulation displacement connector (IDC) block comprising a housing with at least two electrical contacts with IDC elements positioned within the housing and a termination tool;
   the termination tool comprising:
   at least one anchor portion for fixing the termination tool to an IDC block;
   at least one body portion pivotable between an open position and a closed position relative to the IDC block for urging at least one electrical conductor into an IDC element; and
   an integral hinge portion between the anchor portion and the body portion;
pivoting the body portion of the termination tool to the open position;
inserting an electrical conductor into a through-hole of the body portion;
pivoting the body portion into the closed position, wherein the electrical conductor is urged into the IDC element; and
fixing the body portion into its closed position at the IDC block.

The invention also comprises a method of electrically connecting an electrical conductor to an insulation displacement connector (IDC) block, the method comprising:
providing an insulation displacement connector (IDC) block comprising a housing with at least two electrical contacts with IDC elements positioned within the housing and a termination tool;
   the termination tool comprising:
   at least one anchor portion for fixing the termination tool to an IDC block;
   at least one body portion pivotable between an open position and a closed position relative to the IDC block for urging at least one electrical conductor into an IDC element; and
   an integral hinge portion between the anchor portion and the body portion;
pivoting the body portion of the termination tool to the open position;
positioning an electrical conductor in the housing above an IDC element;
pivoting the body portion into the closed position, wherein the electrical conductor is urged into the IDC element; and
fixing the body portion into its closed position at the IDC block.

### BRIEF DESCRIPTION OF THE DRAWINGS

The invention will now be described in more detail with reference to the following Figures exemplifying particular embodiments of the invention:

FIG. 1 is a three dimensional view of a termination tool according to the invention;

FIG. 2 is a cross section through an insulation displacement connector (IDC) block with a termination tool according to the invention;

FIG. 3 is a three dimensional view of an IDC block with a termination tool according to the invention during termination of electrical conductors;

FIG. 4 is a cross section through an IDC block with a termination tool according to the invention and electrical conductors guided through a through-hole in the termination tool; and

FIG. 5 is a cross section through an IDC block with a termination tool according to the invention and electrical conductors guided underneath the termination tool into the IDC block.

### DETAILED DESCRIPTION OF THE DRAWINGS

Herein below various embodiments of the present invention are described and shown in the drawings wherein like elements are provided with the same reference numbers.

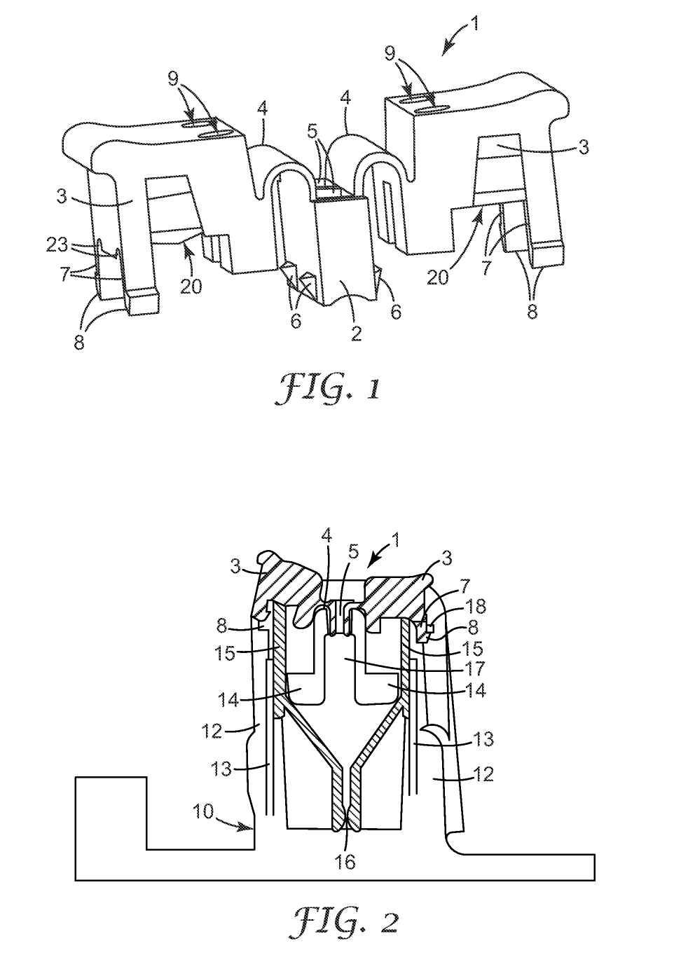

FIG. 1 shows a three dimensional view of a termination tool 1 according to the invention. The termination tool 1 comprises a block shaped anchor portion 2 and two body portions 3. The two body portions 3 are arranged on opposite sides of the anchor portion 2. It is possible to terminate wires to two opposite rows of contacts. With the shown termination tool 1 the anchor portion 2 and the two body portions 3 are each connected via a living hinge portion 4 with each other. The living hinge portions 4 enable the body portions 3 to pivot between an open position and a closed position relative to the anchor portion 2 (those two positions and their function will be described later in more detail).

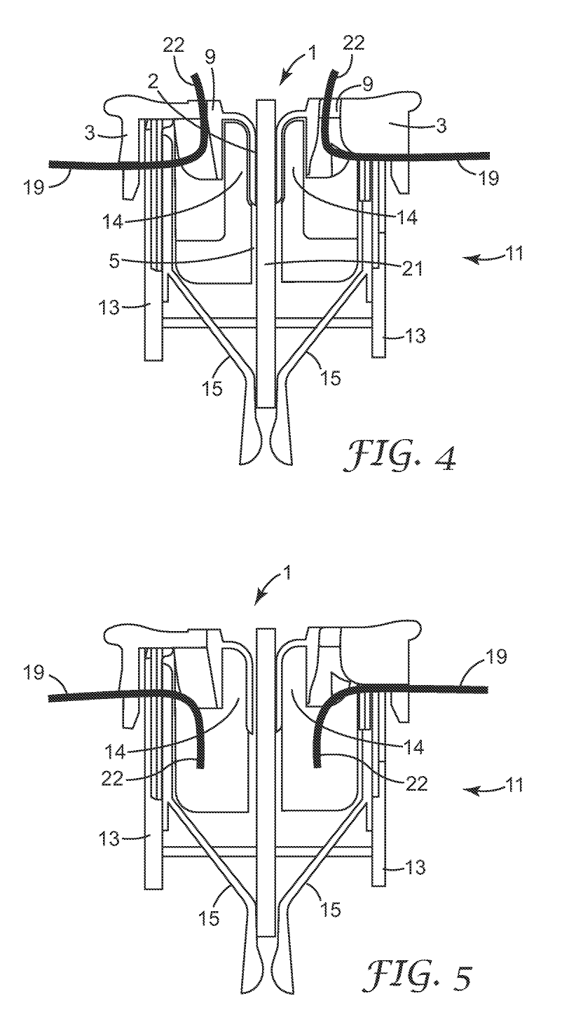

The hinge portions 4 are integrated living hinges extending between an upper part of the anchor portion 2 and side part of the body portions 3. The anchor portion 2 comprises two apertures 5. These apertures 5 are arranged parallel to each other within the anchor portion 2 and extend from the upper part to the lower part of the anchor portion 2. They serve as test access ports and will be described in more detail with reference to FIGS. 2 and 4. The anchor portion 2 also comprises fixing elements in the shape of protrusions 6 that are arranged on the lower part and face the body portions 3. The protrusions 6 cooperate via snap fits to secure the termination tool 1 in an insulation displacement connector (IDC) block (not shown in FIG. 1).

The two body portions 3 have a block shape as well. The upper side is curved. By this pushing the body portion 3 into a closed position by using a finger is facilitated. On the side that faces away from the anchor portion 2, the body portions 3 comprises securing elements in the shape of latches 8 arranged on legs 7 that cooperate via snap fit to secure the body portions 3 in a closed position to the IDC block. To enable the latches 8 to function in this snap fit arrangement the legs 7 should be resilient. The two body portions 3 also comprise guiding areas 20 on their lower side opposite the upper side. Those guiding areas 20 are designed in such a way that it is possible to urge a wire 19 into an IDC element. Since during insertion of the electrical conductor into the IDC element the insulation of the electrical conductor 19 is displaced a certain amount of force has to be applied to the electrical connector. Therefore, the body portion of the termination tool comprises a specially designed area 20 that is capable to guide, force and/or urge the conductor into the IDC element. The guiding area 20 may be adapted to the shape of the electrical conductor 19 and be u-shaped (see entrance 23 of guiding area in FIG. 1) or it may comprise a wire hugger-area and/or a wire stutter-area, whereby the wire stutter would be aligned with the IDC element. When the body portion is swiveled into its closed position, the guiding area 20 engages the electrical conductor 19 and pushes it into the IDC element. Each body portion 3 also comprises two through-holes 9 functioning as wire guides for electrical conductors that are being connected with the termination tool to the IDC block. The termination tool 1 shown in FIG. 1 is adapted for an IDC block with at least two rows of contacts and each body portion 3 is assigned to a pair of contacts in one row.

The termination tool 1 shown in FIG. 1 consists of one single piece that may have been made by an injection moulding process. The termination tool 1 is made out of a material that is resilient enough to allow a swivelling of the body portions 3 relative to the anchor portion 2 and to allow a fixing of the anchor portion 2 and the body portions 3 at the IDC block but rigid enough to allow urging an electrical conductor into an IDC element.

FIG. 2 shows a cross section through an IDC block 11 with the termination tool 1 of FIG. 1. The IDC block 11 comprises a housing 10 having several parts: an outer housing 12, and inner housing 13 and a middle part 14. Within the housing 10 is arranged a pair of contacts on the form of two contact elements 15. At their lower end the two contact elements 15 have a disconnection point 16. At their upper end the two contact elements 15 have IDC elements (not shown) for connecting wires therewith. The termination tool 1 is fixed with its anchor portion 2 at the middle part 14 of the housing 10. The middle part 14 has a gap 17 for receiving the anchor portion 2. The anchor portion 2 is secured in gap 17 by its protrusions 6 (not shown in FIG. 2). The gap 17 may comprise indents or holes that cooperate with the protrusions 6 on the anchor portion 2. In FIG. 2 also can be seen one aperture 5 of the termination tool 1 for the test access port.

The two body portions 3 of the termination tool 1 are shown in FIG. 2 on the right side in a closed position and on the left side in a slightly open position. In the closed position the body portion 3 extends over the inner housing 13 and is fixed with the latches 8 at the end of the legs 7 at a corresponding catch 18 of the inner housing 13. As can be seen from the left body portion 3 of the termination tool 1 it is possible to swivel the body portion 3 relative to the anchor portion 2 and relative to the IDC block 11 over the hinge portion 4.

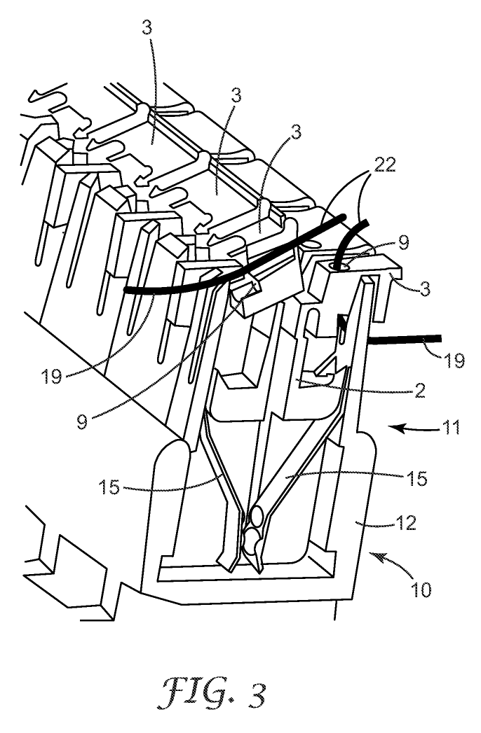

FIGS. 3, 4 and 5 show the IDC block 11 of FIG. 2 during insertion and termination of wires 19. For each contact pair of the two rows of the IDC block 11 has one body portion 3. The anchor portions 2 of the two or more body portions 3 may be connected with each other so that one termination tool is assigned to one IDC block. The first step when an electrical conductor or wire 19 is connected to an IDC block 11 according to the method of the invention is to provide an IDC block 11 with a housing 12, 13, 14 and at least two electrical contacts 15 within the housing 10. The contacts 15 have IDC elements. The IDC block 11 is equipped with the termination tool 1 described in detail with reference to FIGS. 1 and 2. The next step is to pivot the body portions 3 of the termination tool 1 in an open position (see left side of termination tool 1 in FIG. 3). Then the wires 19 that will be connected to the IDC elements of the IDC block 11 may be introduced into the through-holes 9 of the body portions 3 (see also left side of termination tool 1 in FIG. 3). Wires 19 are inserted into the tool between legs 7 so that the free end 22 of the wire extends through through-hole 9. The wires are positioned in entrance 23 of the guiding area 20 to align the wires with the IDC element portion of contact elements 15. By pivoting the body portions 3 into the closed position, the wires 19 are forced or urged into the IDC elements for example by wire stuffing elements pressing on the top surface of the wires 19 (see right side of the termination tool 1 in FIG. 3). The last step is to fix or secure the body portions 3 in a closed position by engaging the latches 8 on the body portion with the catches 18 on the IDC block 11 (see FIG. 2). After termination of the wires 19 they can be cut to the appropriate length, for example shortly above the through-holes 9 of the body portions 3.

FIG. 4 shows a cross section through the IDC block 11 with the termination tool 1 and electrical conductors 19 guided through a through-holes 9 in the termination tool 1. Part of the inner housing 13 and of the middle part 14 of the IDC block 11 and two contact elements 15 of a pair of contacts are shown. The two body portions 3 are shown in their closed and fixed position. Two wires 19 are positioned in the through-holes 9 of the body portions 3. They are inserted into the IDC elements of the contacts 15. They are cut off after termination right above the through-holes 9. A test probe 21 may be inserted from above the IDC block 11 through the aperture 5 of the anchor portion 2 of the termination tool 1 to make contact to the pair of contact elements 15 thereby opening the disconnection point 16.

FIG. 5 also shows a cross section through the IDC block 11 with the termination tool 1 and electrical conductors 19. The difference between the embodiment shown in FIG. 4 and that shown in FIG. 5 is that the wires 19 in FIG. 5 are not guided through the through-holes 9 of the body portions 3 of the termination tool 1. The reason therefore is that in this embodiment the housing 10 of the IDC block 11 is filled with a sealant component, e.g. a gel. The wire extremity 22 of the wire 19 is inserted directly into the housing 10 instead of guided through the through-holes 9 of the body portions 3 of the termination tool 1. This enables the ends 22 of the wires 19 as well as the contacts to be sealed by the gel. For this application the same termination tool 1 can be used for terminating the wires 19 as described above except that the wires 19 have to be cut of to the appropriate length before inserting them into the housing 10 and before termination.

### REFERENCE NUMBERS

1 Termination Tool

2 Anchor Portion

3 Body Portion

4 Hinge Portion

5 Aperture

6 Protrusion

7 Leg

8 Latch

9 Through-Hole

10 Housing

11 Insulation Displacement Connector (IDC) Block

12 Outer Housing

13 Inner Housing

14 Middle Part

15 Contact Element

16 Disconnection Point

17 Gap

18 Catch

19 Electrical Conductor, Wire

20 Guiding Area

21 Test Probe

22 End of Wire

23 Entrance

1. A termination tool for terminating electrical conductors to an insulation displacement connector (IDC) block comprising:
an anchor portion for fixing the termination tool to the IDC block;
a body portion pivotable between an open position and a closed position relative to the IDC block for urging at least one electrical conductor into an IDC element of the IDC block and
an integral hinge portion between the anchor portion and the body portion that enables the body portion to pivot between the open position and the closed position.

2. The termination tool according to claim 1, wherein two body portions are each fixed by an integral hinge portion to the anchor portion.

3. The termination tool according to claim 1, wherein the integral hinge portion (4) is a living hinge.

4. The termination tool according to claim 1, wherein the body portion comprises at least one through-hole for the electrical conductor to pass through the body portion.

5. The termination tool according to claim 1, wherein the body portion comprises a guiding area for urging the electrical conductor into the IDC element of the IDC block.

6. The termination tool according to claim 1, wherein the termination tool comprises at least one aperture to provide a test access to the IDC block.

7. The termination tool according to claim 1, wherein the termination tool comprises at least one opening for filling a sealant into the IDC block for environmental protection.

8. The termination tool according to claim 1, wherein the anchor portion comprises at least one fixing element for fixing the anchor portion to the IDC block.

9. The termination tool according to claim 1, wherein the body portion comprises at least one securing element for securing the body portion in its closed position to the IDC block.

10. (canceled)

11. The termination tool according to claim 1, wherein the termination tool is assigned to at least one row of contacts.

12. An insulation displacement connector (IDC) block comprising:
at least one housing;
at least two electrical contacts with IDC elements positioned within the at least one housing and at least one termination tool according to claim 1.

13. The IDC block according to claim 12, wherein the IDC block comprises a gap for receiving the anchor portion of the termination tool.

14. The IDC block according to claim 13, wherein the anchor portion comprises at least one fixing element for fixing the anchor portion to the IDC block, and wherein the gap comprises at least one indent for cooperating with the fixing element of the anchor portion of the termination tool.

15. The IDC block according to claim 13, wherein the gap also functions as a test access port to enable the insertion of a test probe to engage the contacts in the IDC block.

16. The IDC block according to claim 12, wherein the one body portion comprises at least one securing element for securing the body portion in its closed position to the IDC block, and wherein the at least one housing comprises at least one securing portion cooperating with the securing element of the body portion.

17-18. (canceled)
